(19) United States
(12) Patent Application Publication
(10) Pub. No.: US 2007/0282677 A1
(43) Pub. Date: Dec. 6, 2007

(54) Method and System for Providing Householding Information to Multiple Merchants

(76) Inventor: Brown H. Carpenter, San Francisco, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/421,458

(22) Filed: May 31, 2006

(51) Int. Cl. G06Q 30/00

(52) U.S. Cl. 705/14

(57) ABSTRACT

A method is provided for offering householding information to multiple merchants. Merchant specific loyalty information may be linked with internally generated household identification information. Such information may be presented to merchants as a service in order to eliminate the need for merchants to perform householding analysis on their own data.

### TECHNICAL FIELD

The disclosed embodiments pertain to loyalty programs and more specifically, a method and system for providing householding information to multiple merchants for loyalty purposes.

### BACKGROUND

Merchants grouping individuals for marketing purposes known as “householding” is an established business practice. For example, the direct mail industry has used a householding process to eliminate sending duplicate marketing materials to the same household. If the same individual appears multiple times or the same address or last name shows up multiple times in a database, these individual records are consolidated for purposes of sending a single mailing to that individual or address.

In order to provide more targeted marketing opportunities in an effort to maintain the loyalty of their customers, merchants also have a need to track the purchasing habits of customers not just on an individual basis but also on a household basis. A typical method of tracking households is to issue to each individual of a household a loyalty card that contains the same loyalty identification number. A similar practice has members of a household enter a phone number on a PIN pad at the point of sale that substitutes for the loyalty card. While these methods do allow for a household view, they effectively eliminate any accurate tracking of the individual members of the household. Furthermore, phone numbers may change and loyalty cards can be easily lost or forgotten, causing possible re-enrollment and subsequent loss of continuity from both an individual and householding tracking perspective. Additionally, over time, customer information can become stale which can also skew the collected householding data (e.g., changes in life circumstances such as divorce, children leaving for college, etc. may occur).

Alternatively, householding analysis may also be performed through “back-end” processing of customer data that has been acquired on an individual basis. For example, rather than issuing each individual of a household a loyalty card containing the same loyalty identification number, loyalty cards with unique loyalty identification numbers can be issued on an individual basis “Extract, Transform and Load” (“ETL”) processing can then be performed on customer information (name, address, phone numbers, etc.) that was obtained during the loyalty program enrollment process in order to determine commonalities across customer records that would indicate a householding relationship (e.g., common addresses, phone numbers, last names, etc.). As opposed to the prior strategy of using common householding loyalty identification numbers, this householding strategy enables a merchant to more clearly distinguish and track the behavior of both the individual and the household (so long as individuals do not share their loyalty cards); however, accurate householding analysis during an ETL process requires sophisticated data manipulation techniques in order to standardize and cleanse the data prior to assessing the existence of possible households. While third party data services exist today to provide such householding analysis to merchants, such services can be costly.

Currently, merchants typically maintain their own loyalty identification information and their own household information for their own database of customers. As such, each merchant must spend financial resources to perform essentially the same householding analysis. Given that customers frequent various merchants, what is needed is a method to provide householding information across a customer's or household's common set of merchants. Such a method would eliminate significant costs to a merchant in acquiring and maintaining valuable householding information.

### SUMMARY

The present disclosure relates to a method for providing householding information to multiple merchants. The method comprises receiving a request to provide householding information from a merchant, extracting merchant specific loyalty information, if any, and associated general household information, if any, from each user record of a plurality of user records, and transmitting the extracted merchant specific loyalty information and associated general household information to the merchant, wherein a plurality of entries in the merchant specific loyalty information share the same associated general household information.

The present disclosure also teaches a method for obtaining household information in an identity provider service. The method comprises comparing customer identification information that may have been obtained from individuals during an enrollment process to identify a potential household. Such an enrollment process may pertain, for example and without limitation, to enrolling in a merchant specific loyalty program or enrolling with an identity provider service, as further detailed below. Once a potential household is identified, the method transmits a request to all individuals relating to the potential household to obtain consent to establish a household association. If all individuals consent, the method establishes a household association with all the individuals.

### BRIEF DESCRIPTION OF THE DRAWINGS

FIG. 1 depicts an exemplary biometrically enhanced infrastructure architecture in which householding information may be of use in accordance with an embodiment.

FIG. 2 depicts a flow chart of a customer receiving merchant offerings within the infrastructure architecture set forth in FIG. 1.

FIG. 3 depicts a flow chart of a customer purchase transaction performed within the infrastructure architecture set forth in FIG. 1.

FIG. 4 depicts one embodiment of an identity provider service database that contains customer electronic wallets with merchant specific loyalty identification numbers.

FIG. 5 depicts a matching process to associate a household identification number with householding individuals in accordance with the present invention.

FIG. 6 depicts a flow chart of an opt-in process for householding individuals in accordance with an embodiment.

FIG. 7 depicts the interaction between the merchant system and the identity provider service to transfer householding information in accordance with an embodiment.

FIG. 8 depicts the use of householding information provided by the identity provider service across multiple merchants in accordance with an embodiment.

FIG. 9 depicts the use of merchant specific householding information provided by the identity provider service across multiple merchants in accordance with an embodiment.

FIG. 10 depicts a flow chart of an enrollment process for an identity provider service in accordance with an embodiment.

### DETAILED DESCRIPTION

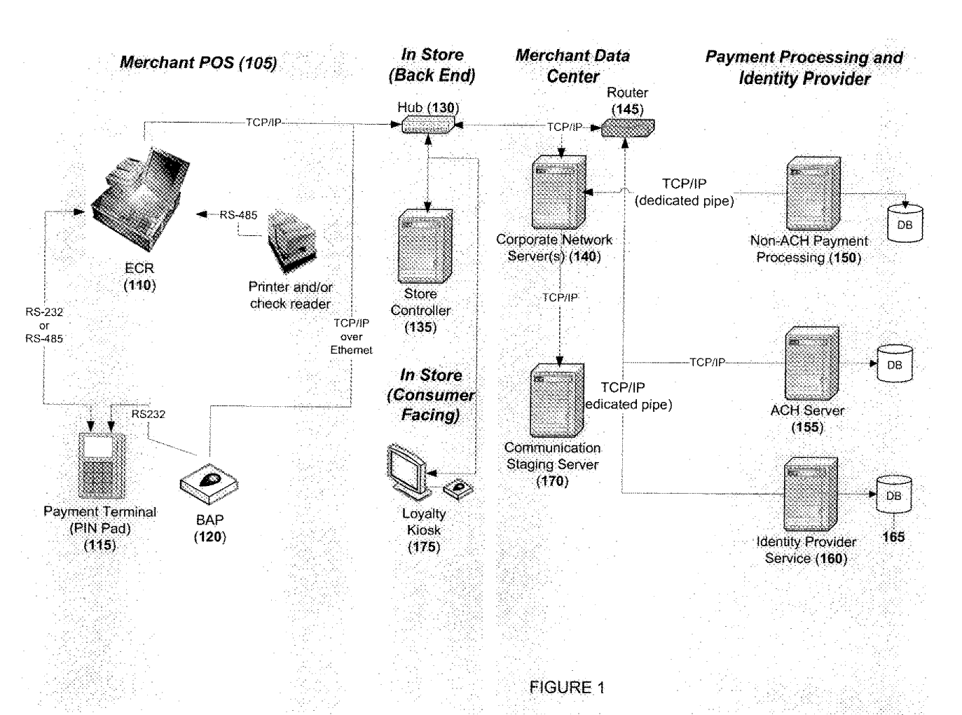

FIG. 1 depicts one embodiment of a biometrically enhanced infrastructure architecture for conducting biometric payment transactions at a merchant location in which the present invention may be deployed. A merchant's point of sale (“POS”) 105 may include an electronic cash register (“ECR”) 110 that is coupled to a PIN pad 115 which is further coupled to a biometric access point (“BAP”) 120. In addition to providing a biometric sensor, the BAP may also contain a processor, memory and software in order to control biometric image capture at the biometric scanner as well as drive or respond to communication from the PIN pad 115 or the identity provider service 160 (as further detailed below). The ECR 110 may be further coupled to other peripheral devices such as a printer or check reader that provides further POS functionality. Both the ECR 110 and the BAP 120 (and the other BAP and ECRs for other POS stations if the merchant has multiple check-out lanes, such as in a supermarket) may be further coupled through a hub 130 to the merchant's specific store controller 135 which may be further coupled to the merchant's cross-store corporate-wide network server 140. The corporate-wide network server 140 may be further coupled to a router 145 which may be further coupled to payment processing services for credit or debit card transactions 150 or for Automated Clearing House (“ACH”) checking transactions 155. The corporate-wide network server 140 may also be further coupled to an identity provider service 160. Such an identity provider service 160 may include a database 165 containing “electronic wallets” of individuals who have enrolled with the identity provider service. Such electronic wallets might include, without limitation, a customer's payment instrument information (e.g., credit cards, debit cards, checking accounts, stored value accounts, etc.), merchant specific loyalty information (e.g., loyalty identification numbers, etc.), biometric information (e.g., fingerprint images, fingerprint templates, etc.) and other personal information of the customer (e.g., unique identification number assigned by the identity provider service 160, name, address, date of birth, driver's license information, email address, etc.). Those with ordinary skill in the art will recognize that the biometric information may alternatively be thought of, conceptually, as providing access to other information in the electronic wallet, rather than being “in” the electronic wallet itself. The identity provider service 160 may have the capability to provide the same biometrically authenticated payment transaction system as further described below across multiple merchants which use a similar infrastructure as detailed in FIG. 1. Additionally, for loyalty purposes, a communication staging server 170 may be coupled to the corporate-wide network server 140. Such a server 170 may manage and store targeted offers (e.g., discounts, Universal Product Code (“UPC”) codes, effective and expiration dates, limits on the number of offers claimable by the same loyalty identification number, etc.) for each customer associated with a merchant specific loyalty identification number. An example of how a communication staging server 170 obtains or otherwise generates offers is found in U.S. patent application Ser. No. 11/283,202, the disclosure of which is incorporated herein by reference in its entirety. A biometrically accessible loyalty kiosk 175 may also be placed at the merchant to provide customers the opportunity to view and activate their targeted offers prior to initiating their shopping experience. Such a loyalty kiosk 175 may also be coupled, via the hub 130, ultimately to the identity provider service 160 and the communication staging server 170. The communication staging server 170 may contain a database of targeted offers associated with each customer loyalty identification number that may be presented to the customer for viewing and activation at the loyalty kiosk 175. Information that may be stored in the database for each offer may include, for example and without limitation, an offer identification number, a UPC code, a discount amount, a limit per loyalty identification number, an effective date, an expiration date and a general description of the offer.

Those of ordinary skill in the art will recognize that the various communication channels and computer systems depicted in FIG. 1 may be implemented in a variety of known techniques and manners. For example and without limitation, rather than using dedicated TCP/IP connections between the corporate-wide network server 140 and the identity provider service 160 and other payment processors 150 and 155, Internet connections may be considered in alternative embodiments. Similarly, rather than having the BAP 120 communicate with the identity provider service 160 through a wired network, alternative embodiments may utilize a wireless network system for communication between the BAP 120 and the identity provider service 160. Similarly, if the merchant's in-store computer network supports wireless networking technology, the ECR 110 may communicate with the store controller 135 wirelessly. As those of ordinary skill in the art will recognize, the communication among the merchant's POS 105, the in-store controller 135, the merchant's corporate-wide network server 140, and various payment processing servers 150 and 155 and the identity provider service 160 may be implemented through a variety of private or proprietary networked connections or through the Internet or other publicly accessible networks. Those of ordinary skill in the art will recognize that the control logic and data stored and used by the various computer systems as described above is merely illustrative and may be distributed throughout the various computer systems' logic controls and databases in alternative but functionally equivalent designs, including without limitation, the removal of certain systems and addition of other systems, without departing from the scope or spirit of the described embodiments. For example, the communication staging server 170 may be coupled to the identity provider service 160 rather than the merchant's corporate-wide network server 140. Similarly, a biometric sensor device (without the additional processing, memory and software capabilities of a BAP 120) may be coupled directly to the ECR 110 and the logic for communication between the biometric sensor device and the identity provider service 160 may be managed by the addition of another server coupled to the store controller 135 in the back of the merchant's location. An alternative embodiment, for example, for a smaller merchant or business, may not utilize a store controller 135 or have a corporate-wide network service 140.

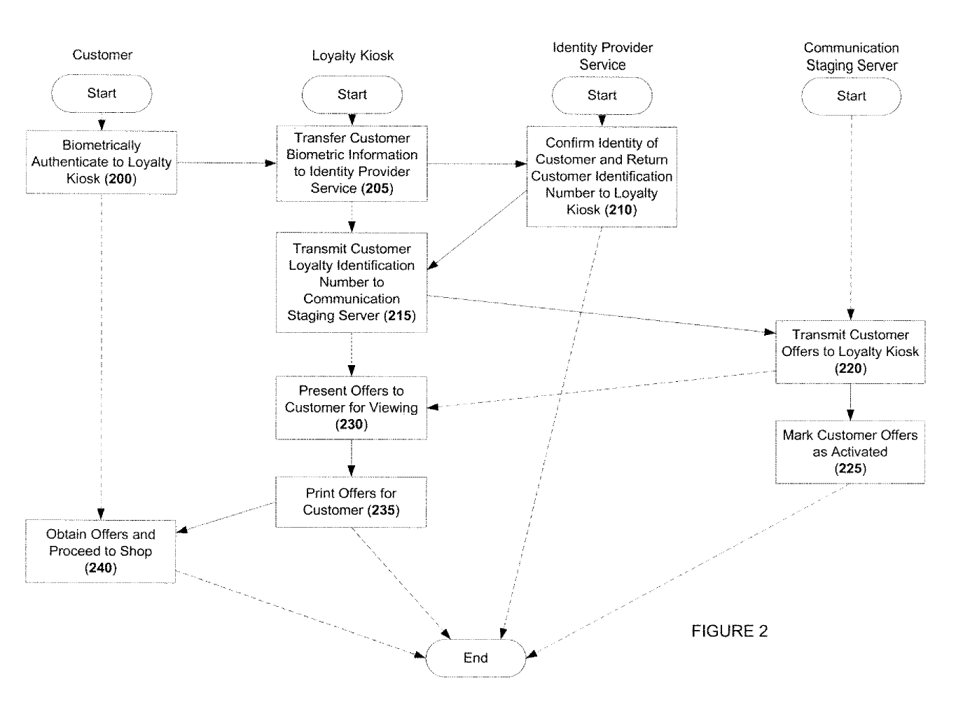

As described in FIG. 2, at step 200, prior to initiating his shopping experience, a customer may visit the loyalty kiosk 175, which may be conveniently situated near the entrance of the merchant, and biometrically authenticate himself at the kiosk in order to view targeted offers associated with the customer's merchant specific loyalty identification number. The customer may place his finger on the biometric sensor on the loyalty kiosk 175 which then captures and produces a representation of the image of the customer's fingerprint. Additionally, the customer may also enter a personal number into the loyalty kiosk 175 to provide further information to the system in order to identify or verify the customer. At step 205, the loyalty kiosk 175 may transmit to the identity provider service 160 the customer's biometric information captured at step 200 (as well as a personal number of the customer, if entered by the customer) and request confirmation of the customer's identity by the identity provider service 160. At step 210, the identity provider service 160, using known methods of comparing biometric information (and utilizing personal numbers) to isolate a customer's electronic wallet in a database, if successful in biometrically authenticating the customer, may confirm the identity of the customer and return the customer's loyalty identification number to the loyalty kiosk 175. At step 215, the loyalty kiosk 175 may then transmit the loyalty identification number to the communication staging server 170 in order to request the offers associated with the customer's loyalty identification number. At step 220, the communication staging server 170 may transmit the offers to the loyalty kiosk 175 which presents those offers to the customer for viewing. The communication staging server 170 may also present to the loyalty kiosk 175 personalized messages for presentation to the customer, including, without limitation, points-based rewards, Consumer Packaged Goods (“CPG”) information, credit balance account information, merchant promotional ads, redemption history, recipes relating to the targeted offers and other targeted messages. Additionally, the communication staging server 170, at step 225, may mark the customer's presented offers as “activated” and ready to be consumed by the customer. At step 230, the loyalty kiosk 175 may present the offers to the customer for viewing and may further print the set of offers for the customer to take with him during his shopping experience in step 235. In step 240, the customer may then proceed to shop at the merchant with his offers in hand. In alternative embodiments, for example and without limitation, the loyalty kiosk 175 may not be biometrically enabled but may present the offers to the customer if the customer enters his loyalty identification number or swipes his loyalty card or other identification card through a card reader coupled to the loyalty kiosk.

Customers may also activate their targeted merchant offers through other channels without using the loyalty kiosk 175 prior to visiting the merchant's store. For example and without limitation, a customer may log into to a merchants website by various alternative login methods (e.g., username and password, loyalty identification number, biometrically, etc.). After obtaining the loyalty identification number of the customer (e.g., either, for example, stored and accessible by merchant's web server after a customer login or by directly requesting the number after customer login), the merchant's web server may communicate with the communication staging server 170 in order to present the customer's offers to the customer through the Internet. Alternative Internet channels may also be envisioned, including, without limitation, having customers access a merchant's targeted offers through an identity management web portal offered by the identity provider service 160. Additionally, the availability of offers may also be sent to customers through mobile phone channels or through email that, for example and without limitation, may include an activation link that, when clicked, may open a new web page providing a view of the offers to the customer. Once a customer has viewed his offers, the communication staging server 170 may mark the offers as activated.

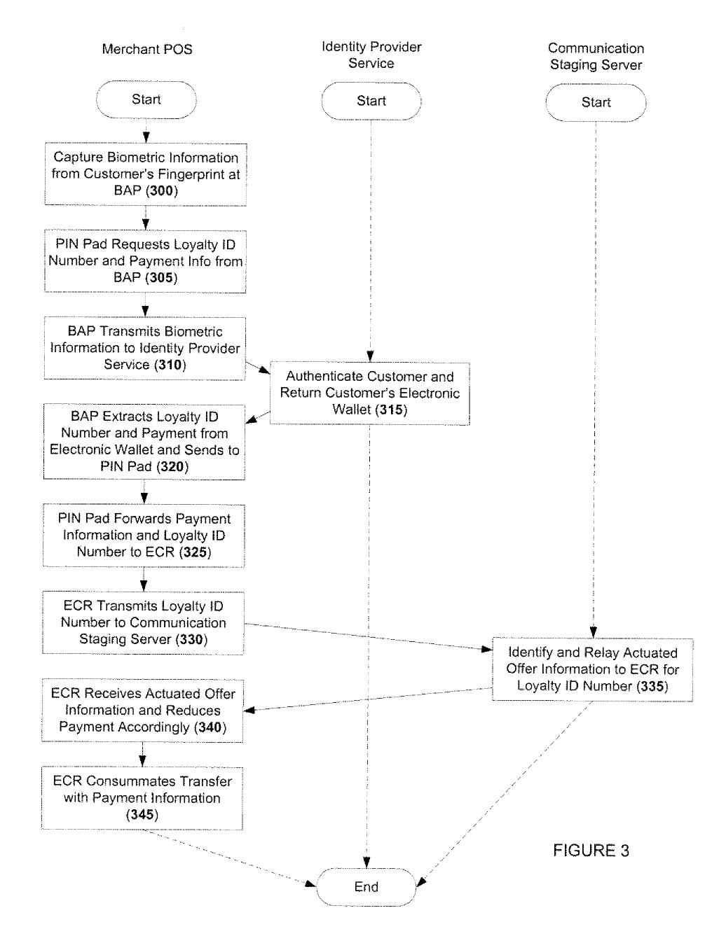

As further detailed in FIG. 3, at step 300, when a customer desires to complete a purchase of goods at the merchant, the customer places his finger on the BAP 120 which then captures and produces a representation of the image of the customer's fingerprint. Additionally, the customer may also enter a personal number into the PIN pad 115 to provide further information to the system in order to identify or verify the customer. At step 305, the PIN pad 115 may request loyalty identification information and payment information associated with the customer from the BAP 120. At step 310, the BAP 120 may transmit the customer's biometric information captured at step 300 (as well as a personal number of the customer, if entered by the customer) to the identity provider service 160 and request that the identity provider service authenticate the customer with the customer's biometric information (and personal number). If authenticated, the identity provider service 160 may return a representation of the customer's electronic wallet that includes the customer's loyalty identification information and payment information (e.g., credit cards, debit cards, checking account, etc.). Those with ordinary skill in the art will also recognize that rather than transmitting the customer's biometric information to the identity provider service 160, the BAP 120 may alternatively request that the identity provider service 160 provide the customer's registered biometric information (obtained during the customer's enrollment with the identity provider service 160) to the BAP 120 for comparison at the BAP 120 (or any other POS peripheral). At step 315, the identity provider service 160, using known methods of comparing biometric information (and utilizing personal identification numbers) to isolate a customer's electronic wallet in a database 165, if successful in biometrically authenticating the customer, may provide the customer's electronic wallet to the BAP 120. At step 320, the BAP 120 may extract the customer's loyalty information and payment information from the customer's electronic wallet and transmit such information to the PIN pad 115. At step 325, the PIN pad 115 may forward the payment information and loyalty information to the ECR 110. At step 330, the ECR 110 may transmit the customer's loyalty information (e.g., loyalty identification number) to the communication staging server 170 and, at step 335, the communication staging server 170 may identity and relay the activated offers relating to that customer's loyalty information back to the ECR 110. Those with ordinary skill in the art will recognize that the communication protocol between the ECR 110 and the communication staging server 170 may be implemented in a variety of ways and through a variety of methods. For example and without limitation, an in-store controller situated between the ECR 110 and the communication staging server 170 may be utilized to provide a relay role between the two devices and/or alternatively, a hosting role by holding the customer's imported offers locally at the particular merchant store. In step 340, the ECR 110 may receive the customer's targeted set of activated offers and then reduce the amount of payment due from the customer in accordance with the customer's set of activated offers. At step 345, the ECR 110 may utilize the payment information (e.g., credit card, debit card, ACH transaction, etc.) in order to consummate the purchase transaction by communicating with the appropriate payment processing servers 150 or 155.

Cross Merchant Householding Identification Service

The infrastructure of a biometrically authenticated payment transaction system similar to that depicted in FIG. 1 provides an opportunity for an identity provider service 160 to provide householding information to multiple merchants without such merchants having to each spend significant resources to obtain such householding information (e.g., ETL processing on their own merchant-specific loyalty database to extract commonalities in customer records).

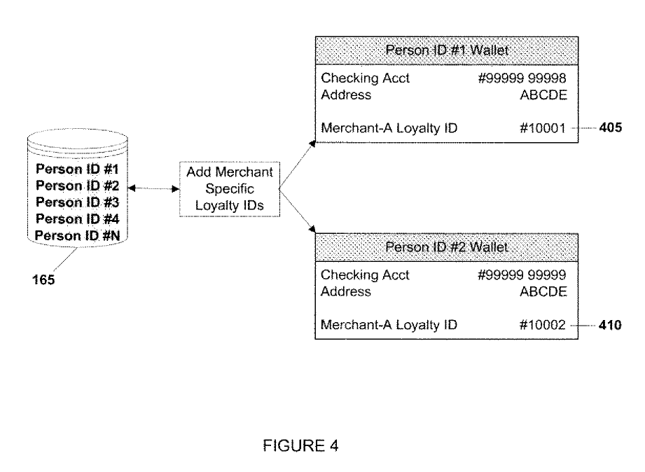

As depicted in FIG. 4, when a customer enrolls in a loyalty program for a merchant that participates in a biometrically authenticated payment transaction system similar to that depicted in FIG. 1, a merchant specific loyalty identification number may be assigned to the customer and stored in the electronic wallet of the customer (see 405 and 410) that is stored in database 165 of the identity provider service 160. Separate from being stored at the identity provider service's database 165, such customer loyalty identification numbers may also be stored in the merchant's own loyalty database (for example and without limitation, coupled to its corporate network server 140) such that the merchant may independently perform loyalty analytics (e.g., transaction log (“TLOG”) loyalty analysis) on consumer purchases and associate the analysis with individual customer behavior.

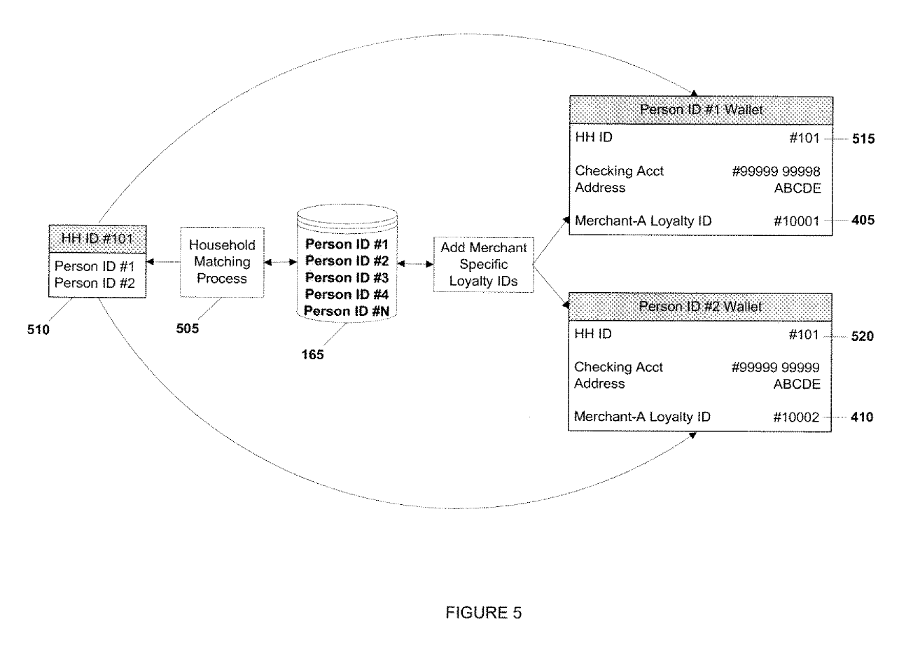

When individuals in a household (e.g., Person ID #1 and Person ID #2 in FIG. 5) have enrolled in the loyalty program for the same merchant, the identity provider service 160 may perform a household matching process 505 on personal information present in the individuals' electronic wallets in the database 165 in order to associate individuals into a household. Those with ordinary skill in the art will recognize that ETL processing techniques, including, without limitation, standardizing and matching addresses, as further described in the Background section herein, may provide the ability to identify individuals in the identity provider service's database 165 that may comprise a common household. Once such analysis is performed (either, for example and without limitation during a merchant loyalty program enrollment of a particular household member or in real-time or in batch mode), the identity provider service 160 may generate a household identification number and associate individuals' identities (e.g., unique identification numbers stored in the electronic wallet that are assigned by the identity provider service 160 during the individual's enrollment with the service) with the household identification number 510. In one embodiment, the linkage between such household identification numbers and individuals' identities may be managed separately by the database 165 (or in a separate database managed by the identity provider service 160) and provided as a specific householding information service by the identity provider service 160 to merchants. In some embodiments, such household identification numbers may be further stored in the electronic wallets of each of the householded individuals (see 515 and 520).

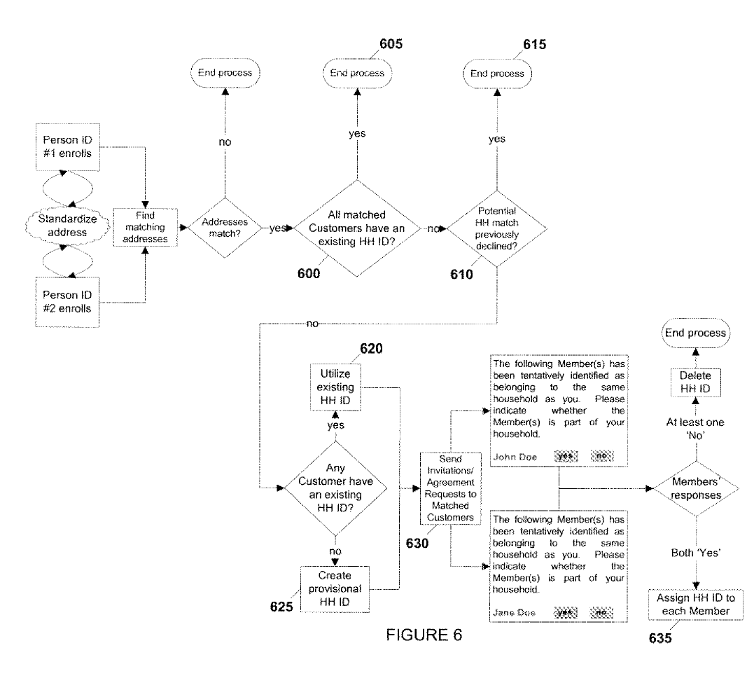

FIG. 6 provides a more detailed flow of an “opt-in” process of householding individuals performed by an identity provider service 160 in accordance with an embodiment. If the household matching process 505 identifies a possible match between two individuals (for example, a matching address), each individual's electronic wallet may be checked for the existence of a pre-existing household identification number. In step 600, if the matching individuals already have a matching household identification number, then the process may end in step 605. In step 610, if at least one of the individuals has previously declined the opportunity to match households with the other matching individual or individuals, the process may end in step 615. In step 620, if one of the matching individuals has a pre-existing household identification number, the other matching individual and all other individuals associated with the household identification number may be sent an invitation (or request for agreement) in step 630 to join the household (or agree to the joining of the new invitee) through any variety of out-of-band communications including, without limitation, one or more email messages and/or one or more notifications when such individuals log into a web site, such as the merchant web site or the identify provider service's identity management web portal. If all solicited individuals agree to the householding event, then in step 635 the identity provider service database 165 may be updated to reflect the household (as further detailed in FIG. 5). Similarly, in step 625, if none of the matching individuals has a pre-existing household identification number, a provisional household number may be generated and if all solicited individuals agree to the householding event, the identity provider service 160 may associate the individuals with the new household identification number.

In addition to the automated householding matching process in FIG. 6, customer service representatives may assist and remind individuals of the capability to create household relationships during an enrollment process, and individuals may initiate householding invitations on their own. For example and without limitation, in order to receive the benefit of better savings and merchant offers based on aggregated household purchases, an individual enrolled with the identity provider service 160 (as opposed to enrolled in a merchant specific loyalty program) may actively choose to extend an householding invitation to another household member that is also enrolled with the identity provider service 160. Such invitation may be transmitted to the other household member through the identity provider service's identity management web portal when the household member logs into such portal, through an email to the invited household member, or any other out-of-band communication channel known in the art. If the invited household member accepts the householding invitation, the household association may be made between the individuals and stored in the database 165. Those with ordinary skill in the art will recognize that other embodiments may also enable individuals to invite household members who are not otherwise enrolled with the identity provider service 160 to also enroll with the identity provider service 160 and may also provide the capability to cancel a household association at any time. Alternative embodiments may keep track of how the householding association is made in the first instance (e.g., automated address matching, customer initiated, etc.) or what common information existed in the electronic wallets of the individuals at the time of the householding event, and if the original criteria between the householded members changes (or common information at the time of the householding event in householded members' electronic wallets change) as reflected by a change in information stored in the electronic wallets of such individuals (e.g., address change, last name change, change in common payment modalities such as credit cards, debit cards, checking accounts, etc.), an invitation to disassociate (e.g., via out-of band channels as previously discussed) such individuals from an established household identification number may be offered by the identity provider service 160. In one embodiment implementing such disassociation capabilities, each householded individual may have a unilateral right to disassociate, in contrast to the consensus agreement between individuals to associate into a household as detailed in FIG. 6.

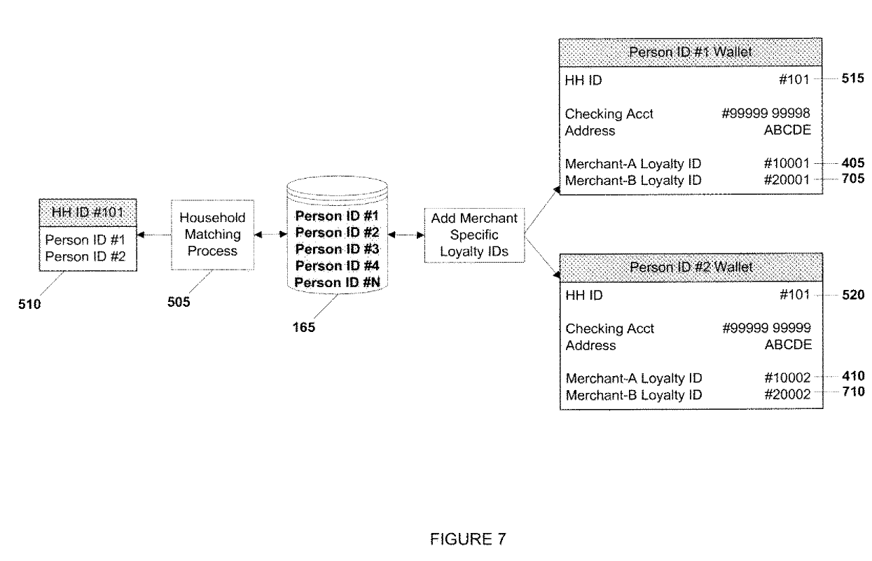

As further detailed in FIG. 7, if the individual further enrolls in the loyalty program of a different merchant, such a merchant's loyalty identification number (see 705 and 710) may also be added to the individual's electronic wallet. Similarly, if a household member of such an individual also enrolls in the loyalty program of such merchant, such a household member may also receive a merchant specific loyalty identification number.

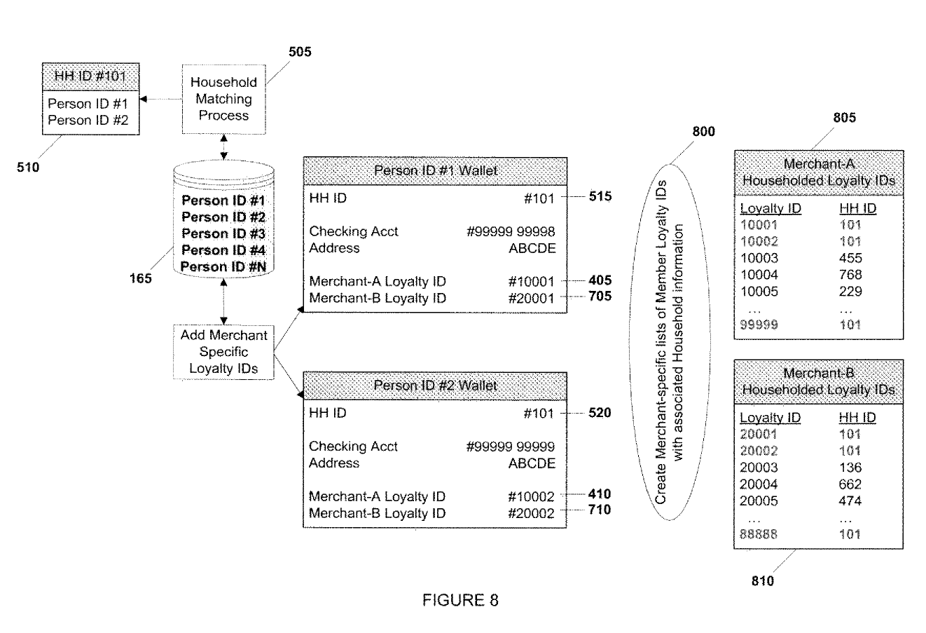

FIG. 8 demonstrates that any merchant that utilizes the identity provider service 160 may benefit from householding information stored in the database 165. For example and without limitation, any such participating merchant may request householding information from the identity provider service 160. A merchant may request such information prior to performing its loyalty analytics on TLOGs in order to assess appropriate levels of loyalty offers for its customers. Upon such a request, the identity provider service 160 may assemble all of the merchant's loyalty identification numbers present in the electronic wallets of individuals enrolled with the identity provider service 160. Due to its householding tracking activities as described above, the identity provider service 160 may also be capable of linking and providing household identification numbers (to the extent existing) with such merchant specific loyalty identification numbers (see 800). The variety of formats available to the identity provider service for providing a response to the requesting merchant shall be evident to those with ordinary skill in the art (e.g., so long as each merchant specific loyalty identification number is linked to the appropriate general household identification number). For example and without limitation, formats similar to 805 and 810 may be sent to the merchant upon a request for householding information. Upon receiving the response from identity provider service 160 that links general householding identification numbers and merchant specific individual loyalty identification numbers, the merchant may perform analytics for its customers at a household level by matching individual purchases reflected in the merchant's TLOGs (which only have the merchant's own specific loyalty identification numbers) with the provided general householding identification number. As such, merchants may efficiently obtain householding information from the identity provider service 160 without spending significant and continual resources in order to independently analyze their own TLOGs and customer loyalty records for householding patterns.

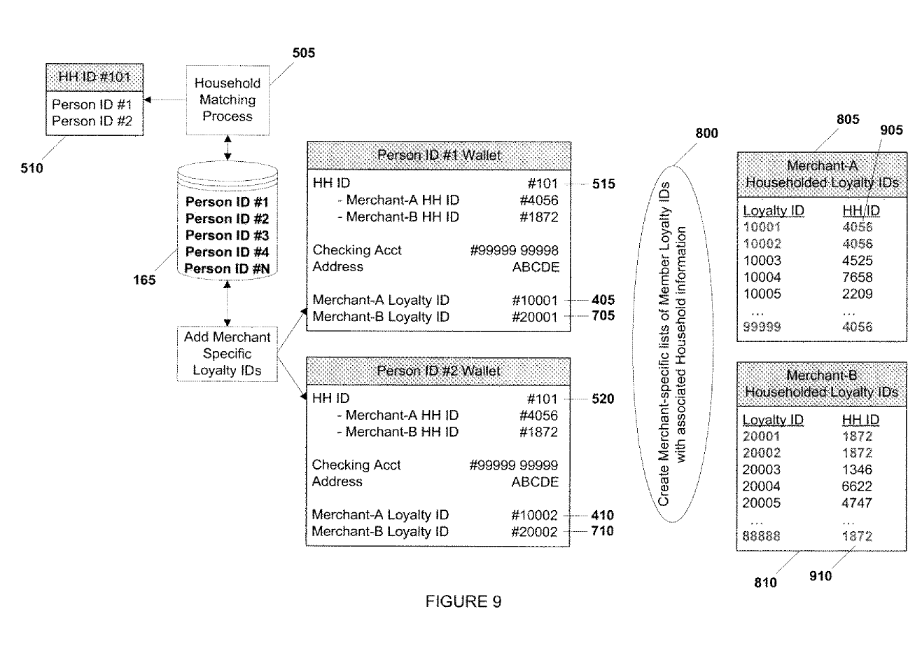

In a further enhanced embodiment as described in FIG. 9, merchant specific household identification numbers may be generated by the identity provider service 160. For example and without limitation, in order to prevent merchants from sharing a common household number (as would have been offered in FIG. 8) to gather further customer purchasing behavior (for customer privacy reasons, for example), the identity provider service 160 may associate a global householding identification number with merchant specific householding identification numbers (see 900). When a merchant requests householding information from the identity provider service 160, the identity provider service 160 may assemble all of the merchant's loyalty identification numbers present in the electronic wallets of individuals enrolled with the identity provider service 160 and link and provide merchant specific household identification numbers (to the extent existing) with such merchant specific loyalty identification numbers (see 905 and 910).

Automated Merchant Loyalty Program Enrollment

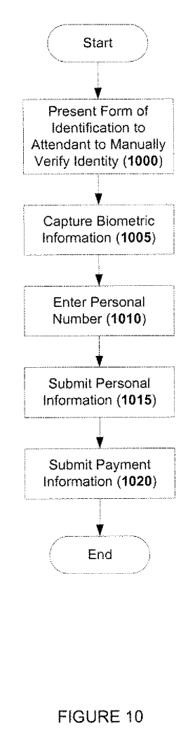

An individual's enrollment with an identity provider service 160 in order to participate in the biometrically authenticated payment transaction system as depicted in FIG. 1 may also provide an opportunity for merchants to offer enrollment of that individual into such merchants' loyalty program. As depicted in FIG. 10, in one embodiment, an individual's enrollment with an identity provider service 160 may take place at an attended enrollment kiosk located at the merchant. During enrollment, at step 1000, the individual may present a form of identification such as a driver's license, identification card, military identification card or passport to the attendant for manual verification of the individual's identity. In step 1005, the individual's biometric information, such as his fingerprint, may be scanned, and the biometric image may be captured. In one embodiment, alternate biometrics, such as a second fingerprint may also be scanned and captured. In step 1010, a personal number, such as the individual's phone number, may be requested to further aid in searching for the registering individual's electronic wallet during a transaction at the POS 105. In step 1015, the individual may be requested to submit personal information such as his first name, last name, address, email address, date of birth, and driver's license number. Such submission may be accomplished through manual typing or swiping or scanning an identification card such as a driver's license. In step 1020, the individual may be requested to submit his payment information such as a checking account for ACH transactions or a credit or debit card number. Such submission may take the form of manual entry or automatic recognition of the information of the cards or checks through swiping or scanning such cards. Those of ordinary skill in the art will recognize embodiments that may enable portions of the enrollment process to be conducted off-line, for example and without limitation, at the identity management web portal of the identity provider service 160. Similarly, those of ordinary skill in the art will recognize that enrollment may be performed and completed without an attendant in certain embodiments.

Because the identity provider service 160 enrollment process already captures the personal information required for a merchant specific loyalty program (e.g., first name, last name, address, email address, pone numbers, date of birth, driver's license, etc.), a merchant may take advantage of the personal information captured by the identity provider service and provide an invitation to enroll in the merchant's own loyalty program either during or after an individual's enrollment process with the identity provider service 160. For example and without limitation, in one embodiment, an individual may log into the identity management web portal of the identity provider service 160 and select any number of participating merchants to participate in their loyalty programs. In alternative embodiments, an individual who is making a purchase at a merchant's POS through a system similar to FIG. 1 may also be prompted and invited to instantly join the merchant's loyalty program, for example and without limitation, by the PIN pad 115 or any other appropriate peripheral. Similarly, enrollment with the identity provider service 160 may be offered at a specific enrollment kiosk located at the merchant, as in FIG. 10, and the individual may be prompted to join that merchant's loyalty program during such an enrollment.

### Persistent Loyalty Identification Number

Storing merchant specific loyalty identification numbers in an individual's electronic wallet that is stored at the identity provider service database 165 and accessing such loyalty identification numbers through a biometrically authenticated payment transaction system similar to that set forth in FIG. 1 and as further detailed in FIGS. 2 and 3 may further address and resolve other problems common to currently existing loyalty programs. Since the system depicted in FIG. 1 biometrically identifies an individual at the POS, the system may eliminate common identity problems that arise in the loyalty data collection process. For example and without limitation, use of such a system may eliminate loyalty data skewing problems that arise when a customer possesses and uses multiple and different loyalty cards, when friendly cashiers at the POS provide generic loyalty identification numbers in the event that customers forget to bring their loyalty cards or have not enrolled in the loyalty program, or when customers share their loyalty cards. One embodiment of a solution in accordance with the present invention may provide the capability for a pre-existing customer of a merchant to obtain and store in his electronic wallet a new and persistent merchant specific loyalty identification number (e.g., merchant provided or approved), for example, during registration with the identity provider service 160, but also enables the customer to retain and store in his electronic wallet any legacy merchant loyalty identification numbers that have been previously used by the customer. Alternatively, the identity provider service 160 may search the merchant's pre-existing loyalty database to find any such legacy loyalty identification numbers that are associated with customers that have enrolled with the identity provider service 160 (e.g., by finding common first name, last name, address and/or phone numbers between the merchant's loyalty database records and the customer's electronic wallet stored at the database 165). Any such identified legacy loyalty identification numbers may be imported by the identity provider service 160 into the customer's electronic wallet. A merchant's own network (e.g., 140) may then be able to query the identity provider service 160 in order to receive the new persistent loyalty identification number as well as the legacy loyalty identification numbers. Both types of loyalty identification numbers may be present in the merchant's POS TLOGs such that the merchant may combine the purchases associated with both the new persistent loyalty identification number (e.g., presented to the ECR 110 when transacting through the system depicted in FIG. 1) and legacy loyalty identification numbers (e.g., presented to the ECR 110 when transacting at merchant locations that do not have such biometrically authentication systems) to identify a single individual (or household as further discussed above) when it conducts its customer analytics.

Although the present invention has been described with reference to the alternative embodiments, those of ordinary skill in the art will recognize that changes may be made in form and detail without departing from the spirit and scope of this disclosure. For example and without limitation, the present invention has been described with reference to a “bricks and mortar” merchant infrastructure as described in FIG. 1. However, those with ordinary skill in the art will recognize that other merchant channels such as, but not limited to, an online or e-commerce transaction architecture or a mobile device transactions architecture could also make use of the claimed invention (if, for example, merchant-specific loyalty identification information is tracked by the merchant in a similar manner as discussed herein in such architectures). Similarly, the present invention has been described with reference to a biometrically enhanced payment infrastructure, and those of ordinary skill in the art will recognize that non-biometrically enhanced payment infrastructures similar in spirit to that described in FIG. 1 may also serve to support the present invention. Terminology used in the foregoing description is for the purpose of describing the particular versions or embodiments only, and is not intended to limit the scope of the present invention which will be limited only by the appended claims. For example, the present disclosure generally relates to providing a method and system for providing householding information to multiple merchants for loyalty purposes. While the term “householding” is used throughout the disclosure, it is not meant to limit the disclosure to any particular type of household, such as a family household. Householding refers generally to a method of consolidating or grouping information about any given person, family, household, company, friends, social network or other identified group. Those of ordinary skill in the art will recognize that householding that is based on groups other than the family may require additional personal information (e.g., other than address) in order to assess the viability of a household by analyzing the personal information obtained during an enrollment through ETL processing techniques. As used herein and in the appended claims, the singular forms “a,” “an,” and “the” include plural references unless the context clearly dictates otherwise. Similarly, the words “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications, additions and substitutions and the like can be made without departing from the spirit of the invention and these are therefore considered to be within the scope of the invention as defined in the following claims.

What is claimed is:

1. A method for providing householding information to merchants, the method comprising:
receiving a request to provide householding indicia from a merchant;
extracting customer loyalty identification indicia specific to the merchant and any householding indicia associated with such customer loyalty identification indicia from a database including customer loyalty identification indicia for a plurality of merchants; and
transmitting the extracted customer loyalty identification indicia and associated householding indicia to the merchant in a format indicating the association between the customer loyalty identification indicia and the associated householding indicia, wherein at least two of the customer loyalty identification indicia share the same associated householding indicia.

2. The method of claim 1 wherein the database stores customer loyalty identification indicia in electronic wallets.

3. The method of claim 2 wherein each electronic wallet contains personal information, including an address of a user associated with the electronic wallet.

4. The method of claim 3 further comprising the step of comparing addresses in each electronic wallet in the database in order to identify household relationships.

5. The method of claim 2 wherein each electronic wallet is capable of storing a plurality of customer loyalty identification indicia for a plurality of merchants and a single associated householding indicia.

6. The method of claim 2 wherein each electronic wallet is capable of storing a plurality of householding indicia.

7. The method of claim 6 wherein each of the plurality of householding indicia relate to different merchants.

8. A system for providing householding indicia to merchants, the system comprising:
a database component for storing customer loyalty identification indicia specific to merchants and associated householding indicia; and
a network server component coupled to the database component for receiving requests from merchants to provide householding indicia.

9. The system of claim 8 wherein the customer loyalty identification indicia specific to merchants and associated householding indicia are stored in the database component as part of electronic wallets including personal information relating to customers.

10. The system of claim 9 wherein the personal information includes address information.

11. The system of claim 10 further comprising a processing component for comparing the address information in each electronic wallet in order to identify householding relationships.

12. The system of claim 11 wherein each electronic wallet is capable of storing a plurality of customer loyalty identification indicia for a plurality of merchants and a single associated householding indicia.

13. The system of claim 9 wherein each electronic wallet is capable of storing a plurality of householding indicia.

14. The system of claim 13 wherein each householding indicia relates to a different merchant.

15. A method for providing householding information to a plurality of merchants, the method comprising:
receiving a request to provide householding indicia from a merchant;
extracting customer loyalty identification indicia, if any, specific to the merchant from each electronic wallet of a plurality of electronic wallets;
extracting householding indicia, if any, from each electronic wallet containing customer loyalty identification indicia specific to the merchant;
generating a list in a format acceptable to the merchant that links the extracted customer loyalty identification indicia to householding indicia extracted from the same electronic wallet;
transmitting the list to the merchant.

16. The method of claim 15 wherein each electronic wallet contains personal information, including an address of a user associated with the electronic wallet.

17. The method of claim 16 further comprising the step of comparing addresses in each electronic wallet in order to identify household relationships.

18. The method of claim 15 wherein each electronic wallet is capable of storing a plurality of customer loyalty identification indicia for a plurality of merchants and a single associated householding indicia.

19. The method of claim 15 wherein each electronic wallet is capable of storing a plurality of householding indicia.

20. The method of claim 19 wherein each householding indicia relates to a different merchant.

21. A computer-readable carrier containing one or more programming instructions for performing a method of providing householding information to a plurality of merchants, the method comprising:
receiving a request to provide householding indicia from a merchant;
extracting customer loyalty identification indicia, if any, specific to the merchant from each electronic wallet of a plurality of electronic wallets;
extracting householding indicia, if any, from each electronic wallet containing customer loyalty identification indicia specific to the merchant;
generating a list in a format acceptable to the merchant that links the extracted customer loyalty identification indicia to householding indicia extracted from the same electronic wallet;
transmitting the list to the merchant.

22. The computer-readable carrier of claim 21 wherein each electronic wallet contains personal information, including an address of a user associated with the electronic wallet.

23. The computer-readable carrier of claim 22 further comprising program code means for comparing addresses in each electronic wallet in order to identify household relationships.

24. The computer-readable carrier of claim 21 wherein each electronic wallet is capable of storing a plurality of customer loyalty identification indicia for a plurality of merchants and a single associated householding indicia.

25. The computer-readable carrier of claim 21 wherein each electronic wallet is capable of storing a plurality of householding indicia.

26. The computer-readable carrier of claim 25 wherein each householding indicia relates to a different merchant.
